(19) United States
(12) Patent Application Publication
(10) Pub. No.: US 2014/0077117 A1
(43) Pub. Date: Mar. 20, 2014

(54) FLUIDTECHNISHES FLACHSCHIEBERVENTIL

(71) Applicant: SAMSON AG, Frankfurt Am Main (DE)

(72) Inventors: JOERG KIESBAUER, Eppertshausen (DE); Frank Valentin-Rumpel, Grob-Umstadt (DE); Helmut Burghardt, Schoenwald (DE); Heinz Albert, Schleifreisen (DE)

(21) Appl. No.: 14/027,471

(22) Filed: Sep. 16, 2013

(30) Foreign Application Priority Data
Sep. 17, 2012 (DE) 10 2012 108 711.3

(51) Int. Cl. F16K 3/02

(52) U.S. Cl. CPC F16K 3/02
USPC 251/329; 29/890.12

(57) ABSTRACT

The invention relates to a flat gate valve for fluid applications having a sandwich design and including at least one input port, one output port, a top plate and a bottom plate, with a sliding element being provided between said top plate and said bottom plate, which sliding element can be used to modify the fluid paths and flow characteristics which are adjusted by the position of the sliding element relative to the top plate and the bottom plate. The invention is characterized in that at least one spacer is provided between said top plate and said bottom plate which defines a distance of said top plate to said bottom plate, which distance is larger by a gap of a defined gap size than the thickness of said sliding element, wherein the sealing of the flat gate valve is exclusively accomplished by means of the set gap.

This patent application claims the benefit and priority of and to German patent application no. DE 10 2012 108 711.3, filed Sep. 17, 2012.

The invention relates to a flat gate valve for fluid applications as well as to a method for its production.

Disclosed in EP 0 102 443 are flat gate valves comprising a top plate and a bottom plate between which a sliding valve element is movably guided. Changing the position of the sliding element relative to said top and bottom plates will change the flow characteristics of the gate valve. This allows flow restrictions or flow path adjustments to be made. As described in this document, a plate-shaped sealing member is provided between a pressure-medium inlet on the base plate and the valve. As a result of the surface pressure between this sealing element and the base plate, said sealing plate causes an increase in pressure which increases the seal effect. Altogether the sealing of the valve is essentially accomplished by means of soft-sealing solutions. Disclosed in DE 2 137 882 is a flat gate valve in which a sliding element is movably mounted between a top plate and a bottom plate, said top and bottom plates being connected via a spacer which has a rubber layer on all sides. This rubber layer should be pre-stressed so as to adjust a beading in the direction of the sliding element, with a seal being provided on the shaft-side end of said sliding element. This seal around the sliding element results in friction between the sliding element and the seal. A generic flat gate valve is also described in FR 1313971.

With soft-sealing gate valves, high friction values are encountered due to the elastomeric seals (“soft seals”) used for which reason some amount of force is required for their adjustment and which—in view of their design—results in down times due to the change-over between the seals of the individual control edges.

Alternatively, a flat gate valve comprises a bottom plate and a top plate which plates apply a normal force to a sliding element disposed between them. In this way, the fluid tightness between these plates is accomplished by means of compression.

This normal force acting on the sliding element results in high friction forces which are several times higher than the friction forces encountered in rotationally symmetric gate valves.

Owing to this type of force-induced seal a lot of power is required for readjusting the gate valve. A prior art flat gate valve comprises a gate valve for fluid applications of a sandwich design having at least one inlet port, one outlet port, a top plate and a bottom plate. Provided between the top plate and the bottom plate is a sliding element which can be used to modify the fluid paths and the flow characteristics. Fluid paths and flow characteristics are adjusted by means of the position of this sliding element relative to said top and bottom plates. In particular, the invention relates to a multi-port valve.

It is the object of the invention to provide low-power control of a flat gate valve. Furthermore, a fast change of control edges is to be made possible so as to avoid down times.

The invention is characterized by a least one spacer being provided between the top plate and the bottom plate of the flat gate valve. Said spacer spaces the top plate from the bottom plate in such a way that the distance is larger by a gap of a defined gap size than the thickness of the sliding element which can be moved between said top and bottom plates. Furthermore, the gate valve is sealed exclusively by means of the adjusted gap.

The invention ensures a fast and low-power switching behaviour for the switching process.

For minimal mass loss of the fluid used in the case of a gap seal, the gap must be as small as possible. In order to still ensure largely friction-free sliding, the gap size should preferably be in the pm range, in particular between 0.5 and 4.0 μm.

For controlling the fluid flow, fluid ducts may be provided in the sliding element which will ensure the actual directional control valve function and provide a connection to the top plate and/or bottom plate where such fluid ports are preferably located.

In yet another advantageous embodiment of the invention, the spacers comprise a base body and a coating. According to the invention, said base body may be of the same thickness as the sliding element. To provide the gap with a defined gap size, a thin layer is preferably disposed between the top plate and/or the bottom plate and the base body of the spacer. Specifically, a coating is provided on the surface of said base body which faces the top plate or the bottom plate.

This constitutes a simple way of providing a gap size in the pm range. In particular, this may be accomplished by using conventional coating or layer-forming methods such as sputtering or screen printing or the like. Accordingly, the spacers are coated with either thin-film or thick-film layers.

In an alternative embodiment of the invention, the particles required for forming the layer may also be deposited on the surface in question in the form of an emulsion.

In a particularly advantageous embodiment of the invention, especially the top plate, the bottom plate and at least the sliding element as well as the base bodies of the spacers are made of ceramic. This constitutes a particularly favourable design of a flat gate valve.

The invention further relates to a method for producing a flat gate valve of the above-mentioned type in which a top plate and a bottom plate are connected via at least one spacer comprising a base body which is provided with a coating. According to the invention, a sliding element is thus produced which is of the same thickness as the body of the spacers. A coating will be applied to at least one surface of the spacer base bodies which faces the top plate or bottom plate. Subsequently, the top plate and the bottom plate will be connected with the spacer. The sliding element will then be inserted in the cavity thus created.

In a particularly advantageous embodiment of the invention, the sliding element and the base body of the spacers are cut out of the same plate-shaped blank. Such an approach is particularly advantageous when ceramics are used since the sintering process used for producing the ceramics will result in a shrinkage of the material. This guarantees that the spacer base body and the sliding element will be of the same thickness. As a result, only the coating will affect the actual dimensions of the seal gap. Especially when tried and tested coating methods such as vapour deposition, sputtering, screen printing or the like are used, the layers to be deposited can be adjusted very precisely. This makes it possible to adjust a gap between the sliding element and the top plates to a size which allows the gate valve to be sealed and still ensures that the sliding element can move almost without any friction. Such coating may for example be a layer produced by means of a thin-film or a thick-film deposition process. As an alternative, an emulsion or extremely thin foils such as gold foil may be applied between the base body of the spacer and the outer top plates.

In yet another preferred embodiment of the invention, a method for producing the flat gate valve may be used in which the sliding element and the spacers are cut out of the same blank of uniform thickness. For adjusting the defined gap size, the surface of the sliding element which faces the top plate or the bottom plate will be reduced in dimension by the gap size, in particular by grinding it down.

Cutting the sliding element and the spacers out of the same blank of uniform thickness allows tolerances to be kept very small which is significant for the sealing effect of a small gap.

As already pointed out above, especially the use of a ceramic material as a blank of uniform thickness is particularly favourable since, on the one hand, the tolerances in the thickness of the blank can be kept very small, and the sliding element can be ground down very precisely, on the other hand.

According to the invention, the grinding process may either be performed before the separation process or after it.

Subsequently, the top and bottom plates enclosing the sliding element may be connected to the spacer by a bonding process or merely by the application of force.

A flat gate valve of the above mentioned type may be advantageously used in process technology applications. The flat gate valve is particularly suitable for use as a solenoid valve. The advantages of the magnetic drive of the sliding element can be fully exploited owing to the low power consumption during switching and the fast switching process made possible.

The flat gate valve according to the invention may preferably be mounted in a positioner. This will ensure excellent control of a drive in view of the low down times.

The flat gate valve of the invention is also suitable for further process technology applications, for example as a quick vent valve or in connection with other accessory equipment.

Further advantages, features and potential applications of the present invention may be gathered from the description which follows, in conjunction with the embodiments illustrated in the drawings.

Throughout the description, the claims and the drawings, those terms and associated reference signs will be used as are notable from the enclosed list of reference signs. In the drawings

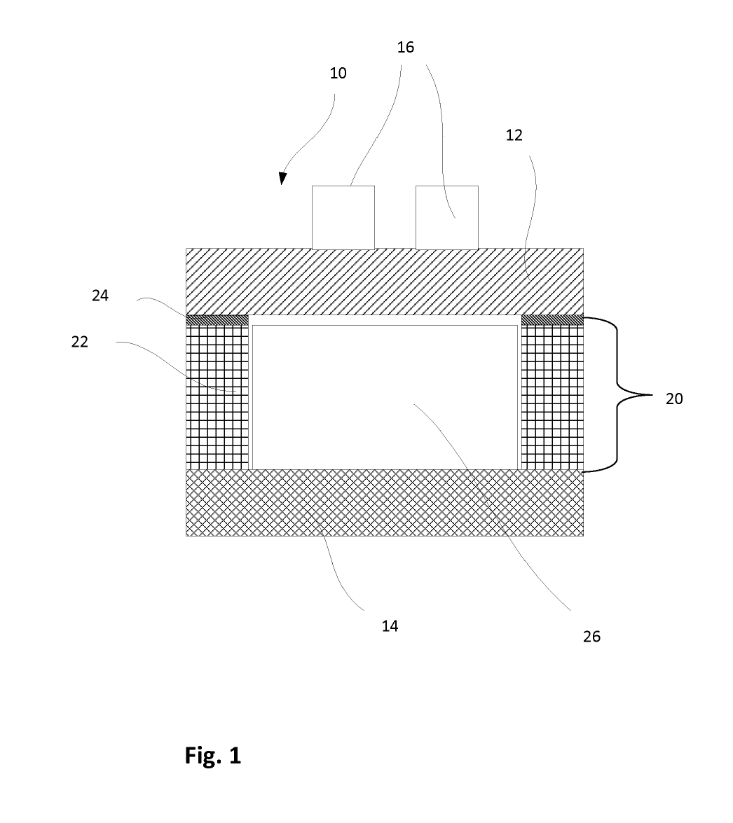

FIG. 1 a schematic sectional view of a gate valve, and

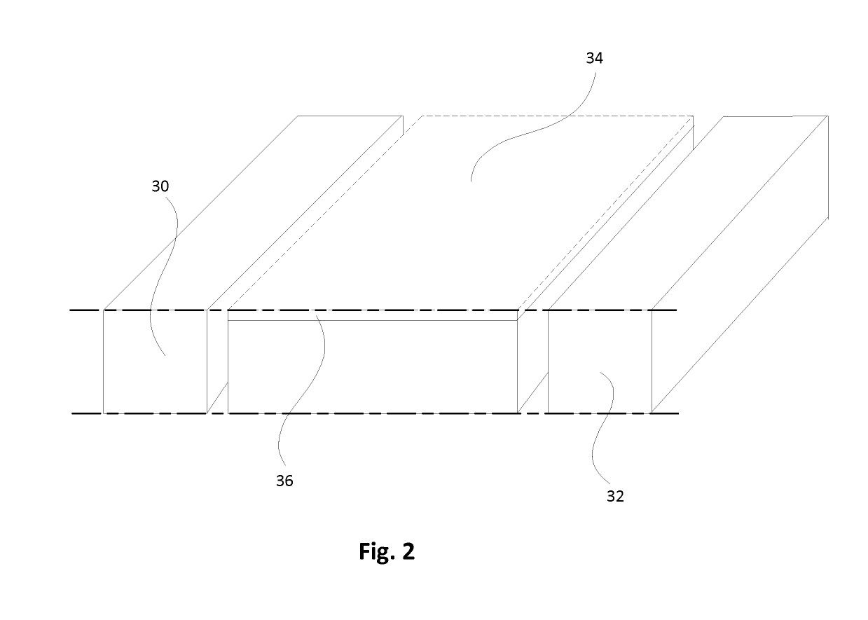

FIG. 2 a schematic view of an intermediate result of a method for producing a flat gate valve.

FIG. 1 is a schematic sectional view of a gate valve 10, which gate valve 10 comprises two outer cover plates, a top plate 12 and a bottom plate 14. Mounted in the top plate 12 are two fluid ports 16.

The top plate 12 and the bottom plate 14 are connected by means of two laterally mounted spacers 20. Said spacers 20 each comprise a base body 22 on which a coating 24 has been deposited.

Disposed in the cavity thus formed is a sliding element 26 which is slidingly accommodated between the top plate 12 and the bottom plate 14.

The sliding element 26 is of the same thickness as the base body 22 of the spacer 20. Ducts are formed in said sliding element and communicate with said fluid ports 16.

Owing to the coating 24 deposited on the spacer 20, a gap size has been set in the pm range. This gap size has been chosen such that it has fluid sealing properties and will still allow the sliding element 26 to be moved with low friction.

FIG. 2 is an intermediate result of a method according to the invention for producing a flat gate valve. The spacers 30, 32 and the sliding element 34 have been cut out of the same plate-shaped blank of uniform thickness.

For setting a gap size between the spacers 30 and 32 and the sliding element 34, the valve body as shown has been ground down by the area 36 indicated by a dotted line. This enables the valve body to move relative to said top and bottom plates largely without friction. At the same time, sufficient sealing is accomplished by the gap of the small defined gap size.

As already described above, in another step of the method, a top plate and a bottom plate are connected by means of the spacers, and the sliding element 34 is movably mounted therebetween.

### LIST OF REFERENCE SIGNS

10 gate valve
12 top plate
14 bottom plate
16 fluid ports
20 spacer
22 base body
24 coating
26 sliding element
30 spacer
32 spacer
34 sliding element
36 area marked by a dotted line

1-15. (canceled)

16. A flat gate valve (10) of a sandwich design for fluid applications, comprising:
at least one inlet port (16);
one output port (16);
a top plate (12) and a bottom plate (14);
a sliding element (26) being disposed between said top plate (12) and said bottom plate (14);
said sliding element (26) positioned relative to said top and bottom plates (12, 14) to adjustably modify fluid paths and flow characteristics;
said sliding element (26) has a thickness;
at least one spacer (20) resides between said top plate (12) and said bottom plate (14);
said spacer defines a distance between said top plate (12) and said bottom plate (14);
said spacer includes a base body (22) and a coating (24);
said base body (22) of said spacer has a thickness;
said coating (24) of said spacer has a thickness;
said distance between said top plate (12) and said bottom plate (14) is larger than said thickness of said sliding element (26);
a gap between said sliding element (26) and said top plate; and,
sealing of said flat gate valve (10) is exclusively accomplished by said gap.

17. The flat gate valve (10) of a sandwich design for fluid applications as claimed in claim 16 wherein said gap size is between 0.5 micrometers and 4.0 micrometers.

18. The flat gate valve (10) of a sandwich design for fluid applications as claimed in claim 16 wherein said sliding element (26) is made of ceramic.

19. The flat gate valve (10) of a sandwich design for fluid applications as claimed in claim 16, wherein:
said base body (22) includes a first surface which faces said top plate (12) and a second surface which faces said bottom plate (14); and,
said coating is deposited on said first surface of said base body (22) which faces said top plate and/or wherein said coating is deposited on said second surface of said base body (22) which faces said bottom plate, and, said thickness of said sliding element (26) is the same as said thickness of said base body (22) of said spacer (20).

20. The flat gate valve (10) of a sandwich design for fluid applications as claimed in claim 19, wherein said coating (24) is a layer produced by means of a thin-film or thick-film coating process.

21. The flat gate valve (10) of a sandwich design for fluid applications as claimed in claim 16, wherein said valve is used in a positioner, as a solenoid valve or as an air-vent valve.

22. A method for producing a flat gate valve (10) in which a top plate (12) and a bottom plate (14) are connected by means of at least one spacer (20) comprising a base body (22) and a coating (24), and a sliding element (26) is movably mounted between said top plate (12) and said bottom plate (14), said sliding element (26) includes a top surface and a bottom surface, comprising the steps of:
producing said sliding element (26) and said base body (22) of said spacer (20) such that they have the same thickness;
coating a top surface of said spacer (20) with a coating such that said coated top surface faces said top plate (12), and/or coating a bottom surface of said spacer (20) with a coating such that said coated bottom surface faces said bottom plate (14);
engaging said coating on said top surface of said spacer (20) with said top plate (12), and/or engaging said coating on said bottom surface of said spacer (20) with said bottom plate (14); and,
producing a gap between said top surface of said sliding element and said top plate (12), said gap size equals the distance between said top plate (12) and said bottom plate (14) minus said thickness of said sliding element (26).

23. The method as claimed in claim 22, further comprising the step of:
cutting said sliding element (26) and said base body (22) of said spacer (20) out of the same plate-shaped blank.

24. The method as claimed in claim 22, wherein said steps of coating a top surface of said spacer (20) with a coating such that said coated surface faces said top plate (12), and/or coating a bottom surface of said spacer (20) with a coating such that said coated surface faces said bottom plate (14) are performed using a thin-film coating process.

25. The method as claimed in claim 22, wherein said steps of coating a top surface of said spacer (20) with a coating such that said coated surface faces said top plate (12), and/or coating a bottom surface of said spacer (20) with a coating such that said coated surface faces said bottom plate (14) are performed using a thick-film coating process.

26. The method as claimed in claim 22, wherein the particles constituting said coating (24) are applied by means of a liquid emulsion.

27. A method for producing a flat gate valve (10) in which a top plate (12) and a bottom plate (14) are connected by means of at least one spacer (20) comprising a base body (22), and a sliding element (26) is movably mounted between said top plate (12) and said bottom plate (14), comprising the steps of:
cutting said sliding element (26) and said base body (22) of said spacer (20) out out of the same plate-shaped blank;
removing a layer from said sliding element (26), said removed layer of said sliding element corresponds to a gap between said sliding element (26) and said top plate (12), said gap equals the distance between said top plate (12) and said bottom plate (14) minus said thickness of said sliding element (26).

28. The method as claimed in claim 27 wherein said step of removing a layer from said sliding element (26) is accomplished by means of a grinding-down step.

29. The method as claimed in claim 27 wherein said step of removing a layer from said sliding element (26) is performed after said step of cutting said sliding element (26) out of said plate-shaped blank.

30. The method as claimed in claim 27 wherein said step of removing a layer from said sliding element (26) is performed before said step of cutting said sliding element (26) out of said plate-shaped blank.
